(19) United States
(12) Patent Application Publication
(10) Pub. No.: US 2018/0307096 A1
(43) Pub. Date: Oct. 25, 2018

(54) TRANSFLECTIVE LIQUID CRYSTAL DISPLAY

(71) Applicant: WUHAN CHINA STAR OPTOELECTRONICS TECHNOLOGY CO., LTD., Wuhan City (CN)

(72) Inventor: Chang XIE, Wuhan City (CN)

(21) Appl. No.: 15/569,771

(22) PCT Filed: Apr. 19, 2017
(86) PCT No.: PCT/CN2017/081033

§ 371 Date: Oct. 27, 2017

(30) Foreign Application Priority Data
Mar. 27, 2017 (CN) 201710188824.X

(51) Int. Cl. G02F 1/1335; G02F 1/1368

(52) U.S. Cl. CPC G02F 1/133555; G02F 1/133603; G02F 1/133528; G02F 1/1368; G02F 1/133514

(57) ABSTRACT

The invention provides a transflective LCD, comprising an LCD panel and a backlight disposed below the LCD panel; the LCD panel comprising a plurality of interleaved transmissive regions and reflective regions; the backlight comprising: a backlight substrate, and a plurality of micro light-emitting diodes (uLED) arrays disposed on backlight substrate; the plurality of uLED arrays being distributed correspondingly on backlight substrate below the plurality of transmissive regions of the LCD panel, the backlight providing backlighting to the plurality of transmissive regions of LCD panel through the plurality of uLED arrays to ensure the light from backlight only propagates and emits from the projection area of transmissive regions and not wasted on reflective regions. As such, the waste of backlight on reflective regions is avoided and the utilization and light efficiency are improved, leading to lower energy consumption of the transflective LCD, saving energy and improving endurance of the display.

### BACKGROUND OF THE INVENTION

### 1. Field of the Invention

The present invention relates to the field of display, and in particular to a transflective liquid crystal display (LCD).

### 2. The Related Arts

The liquid crystal display (LCD) has gone through rapid development and wide range of applications in recent years. The LCD panel usually comprises a color filter (CF) substrate, a thin film transistor (TFT) substrate, a liquid crystal (LC) sandwiched between the C substrate and the TFT substrate, and a sealant; the LC molecules do not emit light, so the display panel requires a light source to display the image. According to the use of different types of light sources, LCD can be divided into transmissive, reflective and transflective.

Wherein the transmissive type LCD panel mainly uses a backlight as the light source, and the backlight is disposed behind the LCD panel. The pixel electrode on the array substrate is transparent electrode and used as the transmissive area, and the light of the backlight is transmitted through the LC layer to display images.

The reflective type LCD mainly uses a front light or external light as the light source. The array substrate uses the reflective electrodes made of metal or other material with good reflective characteristics as reflective area, suitable for reflecting the light from the front light or external light.

The transflective type LCD can be viewed as a combination of transmissive type and reflective type. The array substrate is disposed with both reflective area and transmissive area, and can use backlight, front light or external light as a light source.

The advantage of a transmissive LCD panel is the ability to display a bright image in a dark environment, but the drawback is that the light able to pass through is only a smaller proportion of the emitted light from the backlight and the backlight utilization is not high. To increase the display luminance, the luminance of the backlight must be greatly increased, resulting in high energy consumption. The advantage of the reflective LCD panel is the ability to utilize an external light, causing relatively low power consumption, but the disadvantage is that the image cannot be displayed in the dark due to the dependence on the external light. The transflective LCD panel has the advantages of both transmissive and reflective LCD panels, which can display bright images in dark environments and has lower power consumption when used outdoors. Therefore, the transflective LCD panel is widely used in portable mobile electronic products, such as mobile phones, digital cameras, handheld computers, GPRS and other mobile products.

FIG. 1 is a schematic view showing the structure of a known transflective LCD. As shown in FIG. 1, the transflective LCD comprises a LCD panel 10 and a backlight 20 provided below the LCD panel 10, wherein the LCD panel 10 being divided into a plurality of interleaved transmission regions 105 and reflective regions 106. The backlight 20 comprises a light bar 21, a light-guiding plate 22 provided on the side of the light bar 21, and the LCD panel 10 comprises an upper substrate 11 and a lower substrate 12, disposed opposite to each other, and a liquid crystal layer 13 disposed between the upper substrates 11 and the lower substrate 12. The low substrate 12 is disposed with a reflective layer 14 made of metal material corresponding to the plurality of reflection regions 106 for reflecting light in ambient light incident on the LCD panel 10, to provide display luminance of the reflective regions 106 of the LCD panel 10. The light emitted from the light bar 21 enters the light-guiding plate 22 and is mixed by the light-guiding plate 22, and the light is directed from the upper side of the light-guiding plate 22 toward the LCD panel 10. The light emitted from the backlight 20 is directed simultaneously toward the transmission regions 105 and the reflection regions 106, wherein the light directed to the transmission regions 105 is effectively utilized and the light directed toward the reflection regions 106 is blocked completely by the reflection layer 14, and is wasted.

To solve the aforementioned technical issues, it is imperative to provide a technical solution for improving the utilization ratio of the backlight energy, thereby reducing the power consumption of the transflective LCD, and achieving saving energy and improving the endurance of the display device.

### SUMMARY OF THE INVENTION

The object of the present invention is to provide a transflective LCD, wherein the backlight provides backlighting to the transmissive area of the LCD panel by disposing an micro light-emitting diode array corresponding to the transmissive region, improving the utilization and light efficiency of the backlight and reducing the power consumption of the transflective LCD.

To achieve the above object, the present invention provides a transflective liquid crystal display (LCD), comprising: an LCD panel and a backlight disposed below the LCD panel;
the LCD panel comprising a plurality of interleaved transmissive regions and reflective regions;
the backlight comprising: a backlight substrate, and a plurality of micro light-emitting diodes (uLED) arrays disposed on the backlight substrate;
the plurality of uLED arrays being distributed correspondingly on the backlight substrate below the plurality of transmissive regions of the LCD panel, the backlight providing backlighting to the plurality of transmissive regions of the LCD panel through the plurality of uLED arrays.

According to a preferred embodiment of the present invention, each uLED array comprises a plurality of uLEDs arranged in an array.

According to a preferred embodiment of the present invention, in the backlight, the plurality of uLED arrays is disposed on the direct projection areas by the transmissive regions on the backlight substrate through a micro transfer printing process.

According to a preferred embodiment of the present invention, the position and the shape of the direct projection area by each uLED array on the backlight substrate are the same as the position and the shape of the direct projection area by the corresponding transmissive region on the backlight substrate.

According to a preferred embodiment of the present invention, the LCD panel comprises an upper substrate and a lower substrate, disposed opposite to each other, and a liquid crystal (LC) layer disposed between the upper substrate and the low substrate;
the lower substrate is disposed with a reflective layer corresponding to the plurality of reflective regions.

According to a preferred embodiment of the present invention, the reflective layer is a non-transmissive metal layer.

According to a preferred embodiment of the present invention, the upper substrate is a color filter (CF) substrate, and the lower substrate is a thin film transistor (TFT) array substrate.

According to a preferred embodiment of the present invention, the upper substrate is disposed with an upper polarizer on the side facing from the LC layer;
the low substrate is disposed with a lower polarizer on the side facing from the LC layer.

According to a preferred embodiment of the present invention, the reflective layer provides display luminance to the reflective regions of the transflective LCD by reflecting ambient light incident into the transflective LCD.

The present invention also provides a transflective liquid crystal display (LCD), comprising: an LCD panel and a backlight disposed below the LCD panel;
the LCD panel comprising a plurality of interleaved transmissive regions and reflective regions;
the backlight comprising: a backlight substrate, and a plurality of micro light-emitting diodes (uLED) arrays disposed on the backlight substrate;
the plurality of uLED arrays being distributed correspondingly on the backlight substrate below the plurality of transmissive regions of the LCD panel, the backlight providing backlighting to the plurality of transmissive regions of the LCD panel through the plurality of uLED arrays;
wherein each uLED array comprising a plurality of uLEDs arranged in an array;
wherein in the backlight, the plurality of uLED arrays being disposed on the direct projection areas by the transmissive regions on the backlight substrate through a micro transfer printing process.

Compared to the known techniques, the present invention provides the following advantages: the present invention provides a transflective LCD, comprising an LCD panel and a backlight disposed below the LCD panel; the LCD panel comprising a plurality of interleaved transmissive regions and reflective regions; the backlight comprising: a backlight substrate, and a plurality of micro light-emitting diodes (uLED) arrays disposed on the backlight substrate; the plurality of uLED arrays being distributed correspondingly on the backlight substrate below the plurality of transmissive regions of the LCD panel, the backlight providing backlighting to the plurality of transmissive regions of the LCD panel through the plurality of uLED arrays so as to ensure the light from the backlight only propagates and emits from the projection area of the transmissive regions and not wasted on the reflective regions. As such, the waste of backlight on the reflective regions is avoided and the utilization and light efficiency are improved, leading to lower energy consumption of the transflective LCD, saving energy and improving endurance of the display.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a known transflective LCD;

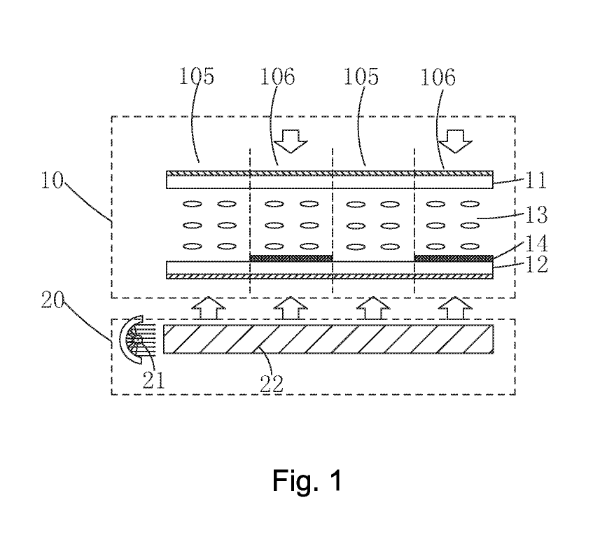

FIG. 2 is a schematic view showing the structure of the transfelctive LCD according to the present invention.

### DETAILED DESCRIPTION OF THE PREFERRED EMBODIMENTS

To further explain the technical means and effect of the present invention, the following refers to embodiments and drawings for detailed description.

Micro light-emitting diode (uLED) technology, that is, the LED miniaturization and array technology, is the technology to integrate a high density micro LED array in a chip, such as, each LED in the LED array can be addressed, singly driven to emit light so that the pixel gap is reduced from the millimeter scale to micrometer scale. The present invention adopts the uLED array to provide backlighting to the transmissive regions of the LCD panel, improves the utilization and light efficiency of the backlight and reduces the power consumption of the transflective LCD.

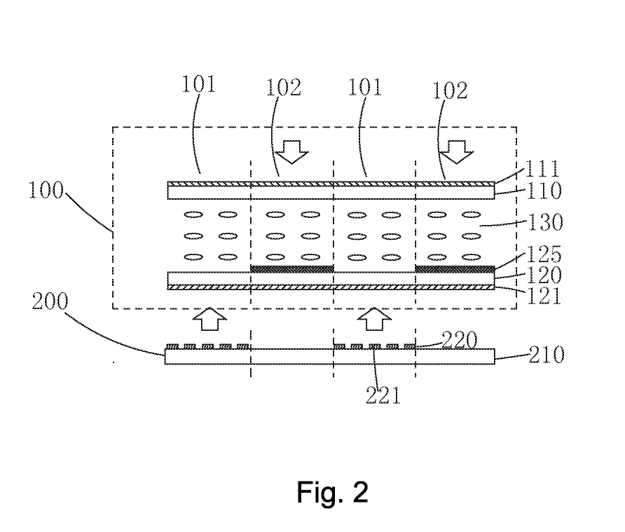

Refer to FIG. 2. The present invention provides a transflective liquid crystal display (LCD), comprising: an LCD panel 100 and a backlight 200 disposed below the LCD panel;
the LCD panel 100 comprising a plurality of interleaved transmissive regions 101 and reflective regions 102;
the backlight 200 comprising: a backlight substrate 210, and a plurality of micro light-emitting diodes (uLED) arrays 220 disposed on the backlight substrate 210;
the plurality of uLED arrays 220 being distributed correspondingly on the backlight substrate 210 below the plurality of transmissive regions 101 of the LCD panel 100, the backlight 200 providing backlighting to the plurality of transmissive regions 101 of the LCD panel 100 through the plurality of uLED arrays 220.

In the transflective LCD of the present invention, the backlight 200 provides backlighting to the plurality of transmissive regions 101 of the LCD panel 100 through the plurality of uLED arrays 220 disposed correspondingly to the transmissive regions 101 so as to ensure the light from the backlight 200 only propagates and emits from the projection area of the transmissive regions 101 and not propagates and emits (i.e., wasted) on the reflective regions 102. As such, the waste of backlight 200 on the reflective regions 102 is avoided and the utilization and light efficiency are improved, leading to lower energy consumption of the transflective LCD, saving energy and improving endurance of the display.

Specifically, each uLED array 220 comprises a plurality of uLEDs 221 arranged in an array.

Specifically, in the backlight 200, the plurality of uLED arrays 220 is precisely disposed on the direct projection areas by the transmissive regions 101 on the backlight substrate 210 through a micro transfer printing process.

Specifically, the position and the shape of the direct projection area by each uLED array 220 on the backlight substrate 210 are the same as the position and the shape of the direct projection area by the corresponding transmissive region 101 on the backlight substrate 210.

Specifically, the LCD panel 100 comprises an upper substrate 110 and a lower substrate 120, disposed opposite to each other, and a liquid crystal (LC) layer 130 disposed between the upper substrate 110 and the low substrate 120;
the lower substrate 120 is disposed with a reflective layer 125 corresponding to the plurality of reflective regions 102.

Specifically, the reflective layer 125 is a non-transmissive metal layer.

Specifically, the upper substrate 110 is a color filter (CF) substrate, and the lower substrate 120 is a thin film transistor (TFT) array substrate.

Specifically, the upper substrate 110 is disposed with an upper polarizer 111 on the side facing from the LC layer 130;
the low substrate 120 is disposed with a lower polarizer 121 on the side facing from the LC layer 130.

Specifically, the reflective layer 125 provides display luminance to the reflective regions 102 of the LCD panel 100 by reflecting ambient light incident into the LCD panel.

In summary, the present invention provides a transflective LCD, comprising an LCD panel and a backlight disposed below the LCD panel; the LCD panel comprising a plurality of interleaved transmissive regions and reflective regions; the backlight comprising: a backlight substrate, and a plurality of micro light-emitting diodes (uLED) arrays disposed on the backlight substrate; the plurality of uLED arrays being distributed correspondingly on the backlight substrate below the plurality of transmissive regions of the LCD panel, the backlight providing backlighting to the plurality of transmissive regions of the LCD panel through the plurality of uLED arrays so as to ensure the light from the backlight only propagates and emits from the projection area of the transmissive regions and not wasted on the reflective regions. As such, the waste of backlight on the reflective regions is avoided and the utilization and light efficiency are improved, leading to lower energy consumption of the transflective LCD, saving energy and improving endurance of the display.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A transflective liquid crystal display (LCD), comprising an LCD panel and a backlight disposed below the LCD panel;
the LCD panel comprising a plurality of interleaved transmissive regions and reflective regions;
the backlight comprising: a backlight substrate, and a plurality of micro light-emitting diodes (uLED) arrays disposed on the backlight substrate;
the plurality of uLED arrays being distributed correspondingly on the backlight substrate below the plurality of transmissive regions of the LCD panel, the backlight providing backlighting to the plurality of transmissive regions of the LCD panel through the plurality of uLED arrays.

2. The transflective LCD as claimed in claim 1, wherein each uLED array comprises a plurality of uLEDs arranged in an array.

3. The transflective LCD as claimed in claim 1, wherein in the backlight, the plurality of uLED arrays is disposed on the direct projection areas by the transmissive regions on the backlight substrate through a micro transfer printing process.

4. The transflective LCD as claimed in claim 3, wherein the position and the shape of the direct projection area by each uLED array on the backlight substrate are the same as the position and the shape of the direct projection area by the corresponding transmissive region on the backlight substrate.

5. The transflective LCD as claimed in claim 1, wherein the LCD panel comprises an upper substrate and a lower substrate, disposed opposite to each other, and a liquid crystal (LC) layer disposed between the upper substrate and the low substrate;
the lower substrate is disposed with a reflective layer corresponding to the plurality of reflective regions.

6. The transflective LCD as claimed in claim 5, wherein the reflective layer is a non-transmissive metal layer.

7. The transflective LCD as claimed in claim 5, wherein the upper substrate is a color filter (CF) substrate, and the lower substrate is a thin film transistor (TFT) array substrate.

8. The transflective LCD as claimed in claim 5, wherein the upper substrate is disposed with an upper polarizer on the side facing from the LC layer;
the low substrate is disposed with a lower polarizer on the side facing from the LC layer.

9. The transflective LCD as claimed in claim 5, wherein the reflective layer provides display luminance to the reflective regions of the LCD panel by reflecting ambient light incident into the LCD panel.

10. A transflective liquid crystal display (LCD), comprising an LCD panel and a backlight disposed below the LCD panel;
the LCD panel comprising a plurality of interleaved transmissive regions and reflective regions;
the backlight comprising: a backlight substrate, and a plurality of micro light-emitting diodes (uLED) arrays disposed on the backlight substrate;
the plurality of uLED arrays being distributed correspondingly on the backlight substrate below the plurality of transmissive regions of the LCD panel, the backlight providing backlighting to the plurality of transmissive regions of the LCD panel through the plurality of uLED arrays;
wherein each uLED array comprising a plurality of uLEDs arranged in an array;
wherein in the backlight, the plurality of uLED arrays being disposed on the direct projection areas by the transmissive regions on the backlight substrate through a micro transfer printing process.

11. The transflective LCD as claimed in claim 10, wherein the position and the shape of the direct projection area by each uLED array on the backlight substrate are the same as the position and the shape of the direct projection area by the corresponding transmissive region on the backlight substrate.

12. The transflective LCD as claimed in claim 10, wherein the LCD panel comprises an upper substrate and a lower substrate, disposed opposite to each other, and a liquid crystal (LC) layer disposed between the upper substrate and the low substrate;
the lower substrate is disposed with a reflective layer corresponding to the plurality of reflective regions.

13. The transflective LCD as claimed in claim 12, wherein the reflective layer is a non-transmissive metal layer.

14. The transflective LCD as claimed in claim 12, wherein the upper substrate is a color filter (CF) substrate, and the lower substrate is a thin film transistor (TFT) array substrate.

15. The transflective LCD as claimed in claim 12, wherein the upper substrate is disposed with an upper polarizer on the side facing from the LC layer;
the low substrate is disposed with a lower polarizer on the side facing from the LC layer.

16. The transflective LCD as claimed in claim 12, wherein the reflective layer provides display luminance to the reflective regions of the LCD panel by reflecting ambient light incident into the LCD panel.
